(19) United States
(12) Patent Application Publication
(10) Pub. No.: US 2009/0115244 A1
(43) Pub. Date: May 7, 2009

(54) Brake Power Generator For A Hydraulic Vehicle Braking System

(76) Inventor: Peter Schluter, Kammerforst (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/988,136

(22) PCT Filed: Jun. 23, 2006
(86) PCT No.: PCT/EP2006/006076

§ 371 Date: Dec. 31, 2007

(30) Foreign Application Priority Data
Jun. 29, 2005 (DE) 10 2005 030 223.8

(51) Int. Cl. B60T 8/40

(52) U.S. Cl. 303/114.1

(57) ABSTRACT

The invention concerns a brake force generator for a hydraulic vehicle braking system with a force input element which can be or is coupled with a brake pedal and is displaceable in a base housing of the brake force generator, a master brake cylinder in which is guided displaceably a primary piston, wherein the primary piston with the master brake cylinder delimits a primary pressure chamber to generate a hydraulic braking pressure, a pedal counter-force simulation device that can be coupled with the force input element and an actuation force generating device to exert an actuation force on the primary piston.

In this brake force generator it is provided that the pedal counter-force simulation device can be or is fluidically coupled with the force input element and that the actuation force generating device has a control valve and a chamber arrangement, wherein the chamber arrangement is formed with a vacuum chamber and a working chamber that is separated from the vacuum chamber by a moveable wall and can be connected fluidically thereto via the control valve, and where the control valve can be controlled mechanically via the pedal actuation to achieve a pressure difference between the working chamber and the vacuum chamber that determines the actuation force.

### CROSS-REFERENCE TO RELATED APPLICATIONS

This application is a National stage of International Application No. PCT/EP2006/006076 filed Jun. 23, 2006, the disclosures of which are incorporated herein by reference, and which claimed priority to German Patent Application No. 10 2005 030 223.8 filed Jun. 29, 2005, the disclosures of which are incorporated herein by reference.

### BACKGROUND OF THE INVENTION

The invention concerns a brake force generator for a hydraulic vehicle braking system and a hydraulic vehicle braking system fitted with such a brake force generator. The brake force generator according to the invention is designed with a force input element that can be or is coupled to a brake pedal and is displaceable in a base housing of the brake force generator, a master brake cylinder in which the primary piston is guided displaceably, wherein the primary piston with the master brake cylinder delimits a primary pressure chamber to generate a hydraulic braking pressure, a pedal counter-force simulation device that can be coupled with the force input element and an actuation force generating device to exert an actuation force on the primary piston.

In braking systems common today, the hydraulic brake pressure necessary to pressurise the wheel brake on the vehicle is mainly generated by means of a master brake cylinder. For this an actuation force must be transmitted to the master brake cylinder, this force being generated in response to actuation of the brake pedal by the vehicle driver. To improve operating comfort, usually the actual brake pedal actuation force is increased by a particular percentage by means of a brake force amplifier so that the brake pedal actuation force necessary for a desired vehicle deceleration can be kept low, such that it is possible for any driver effortlessly to brake the vehicle adequately. Such a braking system with brake force amplifier is known for example from DE 44 05 092, and corresponding U.S. Pat. No. 5,493,946 A1, both of which are incorporated by reference herein.

To increase comfort for the driver, recently braking systems have been designed in which the brake pedal actuation is mechanically decoupled from the actual brake force generation. Rather the brake pedal actuation is detected electronically and a brake force then generated depending on the brake pedal actuation detected. Such solutions are known for example from the prior art according to DE 198 45 052 A1, and corresponding U.S. Pat. No. 6,203,118 B1, both of which are incorporated by reference herein, and DE 100 57 557 A1. In this prior art, the brake pedal actuation is detected electronically and depending on the brake pedal actuation detected, an electromagnetic actuator is triggered which ensures generation or amplification of the brake force.

Furthermore DE 198 17 190 C1 discloses a braking system in which, by means of a pneumatic brake force generator, a brake force is generated at particular wheel brake units. This pneumatic brake force generator is also controlled electronically depending on the brake pedal actuation detected.

In addition the generic prior art according to EP 1 070 006 B1, and corresponding U.S. Pat. No. 6,494,546 B1, both of which are incorporated by reference herein, shows a braking system in which a brake force is generated by means of a hydraulic system, and in normal operation the pedal actuation force remains unused in brake force generation.

The solutions described above from the prior art indeed have the advantage of brake force generation which is partly or even fully decoupled from the brake pedal actuation, but they require considerable complexity in equipment and design. In particular braking systems fitted with electronic actuators according to the prior art above are complex in construction and therefore costly to produce. A further disadvantage of the systems described above is that the pedal counter-force simulation devices used there are in each case arranged directly on a force input element coupled with the brake pedal, which leads to relatively bulky arrangements.

Subsequently published document DE 10 2004 012 263 B3 by the Applicant discloses an arrangement of the type described initially in which the control valve is electromagnetically controlled by means of an additional actuator and hence decoupled from pedal actuation.

In addition document DE 199 14 450 A1, and corresponding U.S. Pat. No. 6,302,497 B1, both of which are incorporated by reference herein, discloses a brake force generator in which a pedal counter-force simulation device is provided in the hydraulic brake circuit attached to the master brake cylinder. This pedal counter-force simulation device can be engaged as required so that the resistance against pedal actuation arising from the master brake cylinder can be increased.

As further prior art which essentially constitutes the technical background, reference is made to documents DE 199 50 862 C5, and corresponding U.S. Pat. No. 6,547,342 B1, both of which are incorporated by reference herein, and DE 601 05 353 T2, and corresponding U.S. Pat. No. 6,494,547 B2, both of which are incorporated by reference herein.

### BRIEF SUMMARY OF THE INVENTION

It is an object of the present invention to provide a brake force generator of the type described initially and a braking system equipped therewith which, in relation to the prior art, has sufficiently good function with a simpler and hence cheaper construction.

This object is achieved by a brake force generator of the type described above in which it is provided that the pedal counter-force simulation device is or can be coupled fluidically with the force input element and that the actuation force generating device has a control valve and a chamber arrangement, wherein the chamber arrangement is formed with a vacuum chamber and a working chamber that is separated from the vacuum chamber by a moveable wall and can be connected fluidically therewith via the control valve, and wherein the control valve can be controlled mechanically directly via the pedal actuation to create a pressure difference between the working chamber and the vacuum chamber that determines the actuation force.

The invention proposes that complicated electromagnetically controllable actuators are replaced and the control valve is actuated mechanically directly via the pedal actuation. The actual generation of an actuation force transferred to the master cylinder takes place via the chamber arrangement with a pressure difference present at the moveable wall and decoupled from the brake pedal, so that the driver himself opens and closes the control valve by his brake pedal actuation, but is decoupled from the actuation force generation. This again means that apart from the coupling between the brake pedal and control valve, the pedal actuation force remains unused for generation of the actuation force and is dissipated in the pedal counter-force simulation device. The fluidic coupling of the pedal counter-force simulation device allows this to be spatially arbitrarily arranged, and thus eliminates the disadvantage of direct spatial allocation of the pedal counter-force simulation device and force input element close to the brake pedal. As a result, bulky brake force generator arrangements are avoided. Rather the pedal counter-force simulation device can be arranged at a location where there is sufficient space available.

A refinement of the invention provides that the control valve has a control valve housing displaceable relative to the base housing and a control valve element displaceable relative to the control valve housing, wherein on the control valve housing is provided a vacuum-tight seat which can be brought into sealing contact with the control valve element, where furthermore mechanically coupled with the force input element is a control valve sleeve on which is provided an atmosphere-tight seat which can be brought into sealing contact with the control valve element. In this context furthermore it can be provided that on sealed contact of the control valve element with the atmosphere-tight seat with simultaneous separation of the control valve element and vacuum-tight seat, the working chamber is fluidically connected with the vacuum chamber, and that on sealed contact of the control valve element with the vacuum-tight seat with simultaneous separation of the control valve element and atmosphere-tight seat, to build up a pressure difference between the working chamber and the vacuum chamber, the working chamber is fluidically connected with the surrounding atmosphere.

In order to achieve the above decoupling of the brake pedal from the actual brake force generation in normal operation of the brake force generator, a refinement of the invention provides that the control valve housing and control valve sleeve are mechanically decoupled from each other, and only after a predetermined relative movement towards each other overcoming a play s do they achieve mutual contact. The play s must be dimensioned such that in case of a failure of the actuation force generating device, for example because the chamber arrangement no longer functions correctly or the vacuum supply to the vacuum chamber has failed, a purely mechanical braking can be performed. After overcoming the play s the control valve housing and the control valve sleeve come into mutual contact, so that further movement of the control valve housing via the brake pedal leads to a direct mechanical movement of the control valve housing and finally to a purely mechanical actuation force generation. The play s is thus overcome in an emergency situation so that purely mechanical braking can be performed. The play s should however not be made too large, so that the idle travel to be overcome in such an emergency situation is not too great.

Furthermore in this context it can be provided that the control valve housing and the control valve sleeve can be moved relative to each other by a spring element under pretension. The spring element must be designed sufficiently strong to prevent, in normal operation, a mechanical coupling of the control valve housing and control valve sleeve.

A refinement of the invention proposes that the vacuum chamber, to generate a vacuum pressure, is fluidically connected with the intake manifold of a combustion engine or with a vacuum pump.

Furthermore according to the invention it can be provided that the chamber arrangement is designed as a tandem chamber arrangement with a first chamber arrangement and a second chamber arrangement separate therefrom, the first chamber arrangement having a first vacuum chamber and a first working chamber separated therefrom by a first moveable wall, furthermore the second chamber arrangement having a second vacuum chamber and a second working chamber separated therefrom by a second moveable wall, wherein the first and second chamber arrangements can be pressurised via the control valve.

As already outlined above, an essential feature of the invention is that the pedal counter-force simulation device is fluidically coupled with the force input element. For this it can be provided that the force input element is coupled via a transfer piston arrangement with the pedal counter-force simulation device. A refinement of the invention provides that the pedal counter-force simulation device can be coupled via a pedal counter-force hydraulic system with a damper arrangement in a force-transmitting manner. In this connection it can also be provided that the damper arrangement has a simulation spring that can be compressed via a force piston displaceable under the pedal counter-force hydraulic system, and/or fluidic damping means, preferably a choke, and/or a resilient stop plate.

The pedal counter-force hydraulic system must also be controlled as a function of the present operating state of the brake force generator. In particular in one embodiment of the invention it is provided that the pedal counter-force simulation device can only be active if the rest of the brake force generator functions properly. If namely the actuation force generating device fails, for example because the chamber arrangement or vacuum supply to the vacuum chamber no longer functions correctly, it is provided that the pedal counter-force simulation device exerts no additional pedal counter-forces against pedal actuation. Rather in such an emergency case the entire pedal actuation force applied by the driver would in fact also be used for purely mechanical actuation force generation. In this case therefore the pedal counter-force simulation device must be deactivated. For this one embodiment of the invention provides that the pedal counter-force hydraulic system is formed with a controllable shut-off valve that in a first position, preferably in its passive position, allows the damper arrangement and the transfer piston arrangement to be hydraulically decoupled from each other and an essentially undamped movement of the transfer piston arrangement, and that in a second position, preferably its active position, couples the damper arrangement and the transfer piston arrangement together hydraulically. Furthermore in this connection it can be provided that the pedal counter-force hydraulic system is fitted with a choke element which in the active position of the shut-off valve chokes a hydraulic fluid flow to the damper arrangement. Preferably it is provided that the shut-off valve at the start of a brake pedal actuation is switched from its passive position to its active position and the control is switched from its active position into its passive position only after completion of the brake pedal actuation. This means that the shut-off valve returns automatically to its passive position and is then in a state in which the pedal counter-force simulation device does not hinder a purely mechanical actuation force generation.

A refinement of the invention provides that the master brake cylinder is formed in a cylinder housing, preferably as a cylinder bore open on one side. It can be provided that the cylinder housing together with components arranged therein can be inserted as an assembly in the base housing and is detachably connected therewith.

To increase the safety of the braking system according to the invention, two separate hydraulic brake circuits are provided. In order to supply these two brake circuits fluidically, the brake force generator according to the invention in a further embodiment is formed so that a secondary piston is guided displaceably in the master brake cylinder, that the secondary piston with the master brake cylinder encloses a secondary pressure chamber to generate a hydraulic braking pressure, and that the primary piston with the master brake cylinder and the secondary piston encloses the primary pressure chamber to generate a hydraulic braking pressure. Furthermore in this connection it can be provided that the primary piston is fitted with a through bore in which is guided an actuation piston, wherein the actuation piston has an actuation cylinder bore in which is guided displaceably a transfer piston of the transfer piston arrangement, wherein the transfer piston in the actuation piston delimits a hydraulic fluid chamber that is fluidically coupled with the hydraulic system of the pedal counter-force simulation device. Advantageously the actuation piston is fixed relative to the primary cylinder.

The invention furthermore concerns a vehicle braking system with a brake force generator of the type described above.

The use of such a brake force generator is suitable in particular in modern vehicles with hybrid drive. Such vehicles conventionally comprise a combustion engine and an additional electric motor or other drive source which is engaged as required. Furthermore such hybrid vehicles have a technical device which allows the kinetic energy of the vehicle, which must be dissipated on desired deceleration, to be converted and temporarily stored in order to be used for drive purposes when continuing the journey. For example an electric motor provided in such a hybrid vehicle is used as a generator during deceleration of the vehicle and the electrical energy generated is temporarily stored in an accumulator. This deceleration caused by the generator effect of the electric motor must be taken into account in the braking system. In other words, this means that in the case where the driver actuates the brake pedal, whereupon the electric motor is activated as a generator, the actual braking system of the vehicle must first be held essentially passive as long as the deceleration requested by the driver via the brake actuation does not exceed the deceleration effect that could be achieved by the electric motor acting as generator. According to an embodiment variant of the braking system of the invention, it is thus provided that the motor vehicle is fitted with a generator used for deceleration and that the vehicle deceleration achieved on activation of the generator is taken into account in the control of the braking system.

Starting from this embodiment variant, the braking system according to the invention further provides that it has a fluidic brake circuit communicating with the master brake cylinder, in which circuit is provided at least one fluid accumulator, wherein the at least one fluid accumulator can be filled with hydraulic fluid from the fluidic braking circuit as long a nominal deceleration momentarily necessary to brake the vehicle does not exceed the maximum vehicle deceleration that can be achieved by activating the generator. This means that because of the direct mechanical coupling between the brake pedal and the control valve, an actuation force is generated by the actuation force generating device which then finally also leads to a displacement of the primary piston and where applicable the secondary piston in the master brake cylinder. The hydraulic fluid transported in reaction to this in the hydraulic brake circuit does not however lead to a perceptible pressure build-up and hence to a hydraulic control of individual wheel brake units, but is “buffered” by at least one fluid accumulator. To apply this buffering only as required i.e. in the case of regenerative braking in which the generator is activated, a refinement of the invention provides that between the fluidic brake circuit and the fluid accumulator is provided a controllable change-over valve that in its non-controlled passive position separates the fluid accumulator from the fluidic brake circuit and in its controlled active position, in particular in the time while the nominal deceleration momentarily required to brake the vehicle does not exceed the maximum vehicle deceleration that can be achieved by activating the generator, connects the fluid accumulator with the fluidic brake circuit.

This however also means that if the vehicle deceleration achievable via the generator effect is no longer sufficient to correspond to the vehicle deceleration required by the driver, the conventional braking system of the vehicle must be activated in a manner which takes into account the braking effect of the generator. For this in principle there are two alternatives, namely

(i) an additive superposition of the braking effect of generator and conventional braking system, wherein the braking effect of the conventional braking system is reduced by the generator braking effect, and
(ii) disengaging the generator at the time at which the vehicle deceleration achievable via the generator effect is no longer sufficient to correspond to the vehicle deceleration requested by the driver, and simultaneous correspondingly intensive control of the conventional braking system in order to perform a continuous smooth (constant) braking.

Both alternatives can be used according to the invention.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an overview depiction of the braking system according to the invention with the brake force generator according to the invention and

FIG. 2 is an enlarged view of the brake force generator according to the invention.

### DETAILED DESCRIPTION OF THE INVENTION

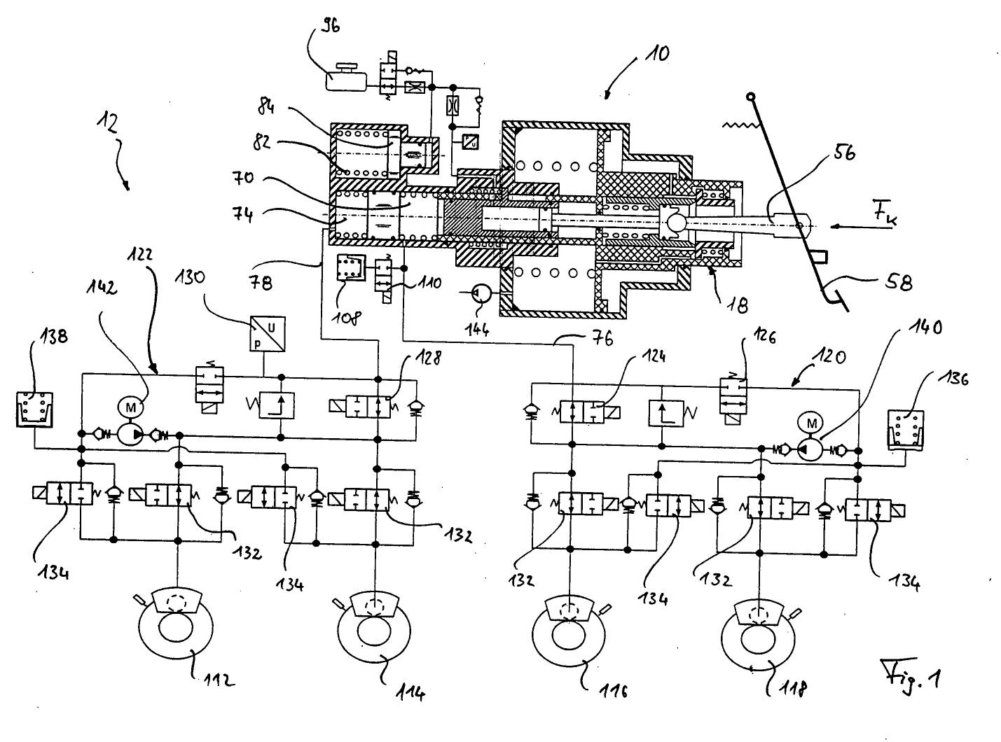

FIG. 1 shows a brake force generator according to the invention, generally designated as 10, which is integrated into a braking system 12 according to the invention. Before the braking system according to the invention is explained in construction and function, first we will discuss in detail the brake force generator according to the invention.

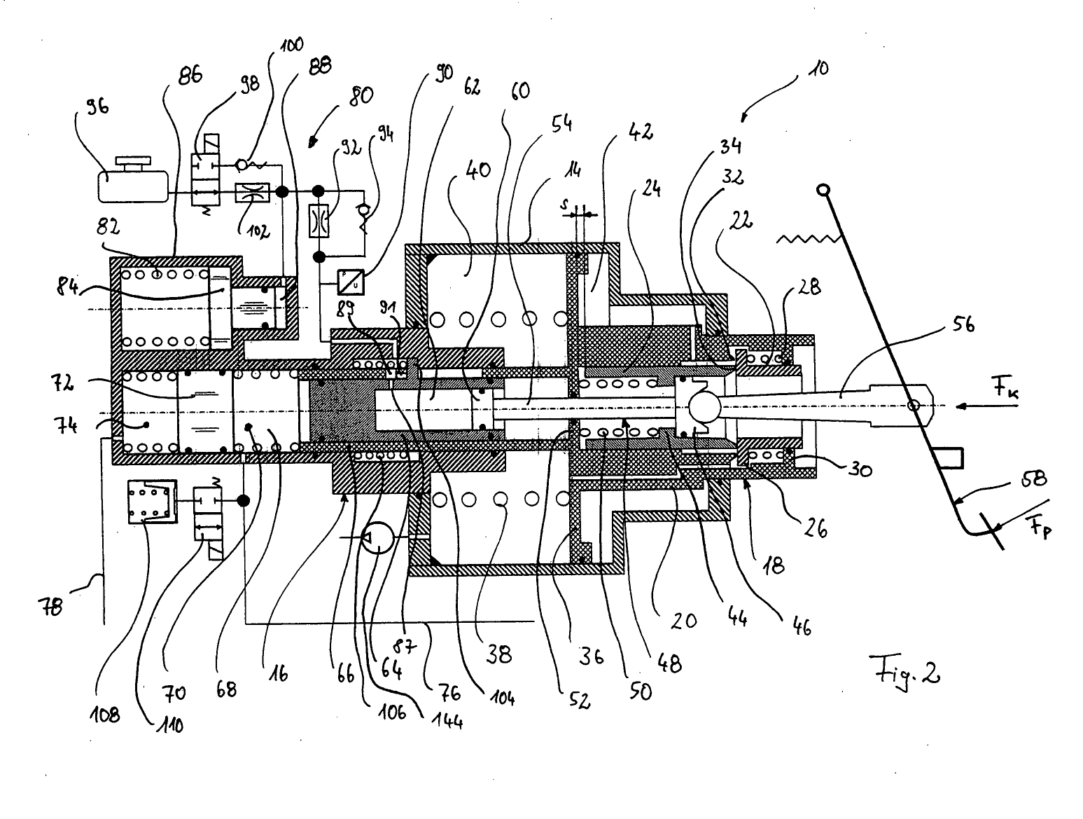

The brake force generator according to the invention comprises a cylinder housing 14 which on the left-hand side in FIG. 2 holds a master brake cylinder 16 and in which is inserted a control valve 18. The control valve 18 comprises a control valve housing 20, a control valve element 22 and a valve sleeve 24. Formed on the control valve element 22 is a flange 26 on which rests a pretension spring 28. The pretension spring 28 is supported at the other end on a collar 30 in which the control valve element 22 is guided displaceably with sealing effect. On the end of the flange 26 facing away from the pretension spring 28, said flange together with the facing sections of control valve housing 20 and valve sleeve 24 forms a vacuum-tight seat 32 and an atmosphere-tight seat 34, the function and significance of which will be described in more detail below.

On the control valve housing 20 is established a moveable wall 36 which via a pretension spring 38 pretensions the control valve housing 20 in the position shown in FIG. 2 and after displacement ensures a return movement. The moveable wall 36 is guided sealed in the cylinder housing 14 and divides the cylinder housing 14 into a vacuum or reduced pressure chamber 40 and a working chamber 42. The vacuum chamber 40 is, as indicated at 144, connected with a vacuum source or with an intake tract of a combustion engine of a motor vehicle fitted with the braking system according to FIG. 1, so that therein is established a pressure reduced in relation to atmospheric pressure. The working chamber 42 however can be connected optionally with the vacuum chamber 40 or with the ambient atmosphere, as will be discussed in more detail below.

The valve sleeve 24 also has a collar 44. On the collar 44 at one end rests a piston section 46 of a transfer piston 48. On the opposite side of the collar 44 rests a pretension spring 50 which with its other end rests on a guide collar 52 that guides a shaft 54 of the transfer piston 48 in a sealed manner. The piston section 46 at its end pointing away from the shaft 54 holds a ball head of a force input element 56 which is connected directly mechanically with a brake pedal 58. On actuation of the brake pedal with a pedal actuation force Fₚ, a force Fₖ acts on the force input element.

Referring now back to the transfer piston arrangement 48, it can be seen that this at its left-hand end in FIG. 2 has a further piston section 60 which is guided in a sealed manner in a cylindrical blind hole bore 62 in an actuation piston 64. The actuation piston 64 is guided in a sealed manner displaceably in the primary piston 66, wherein the primary piston 66 is guided in a cylinder bore 68 in the master brake cylinder 16. The actuation piston 64 and the primary piston 66 at one end terminate a primary chamber 70 in the master brake cylinder 16 which at its other end is terminated by a secondary piston 72. The secondary piston 72 with the housing of the master brake cylinder 16 encloses a secondary chamber 74.

The primary chamber 70 is connected via a hydraulic line 76 with a primary brake circuit 120 of the braking system shown in FIG. 1. The secondary chamber 74 is connected via a hydraulic line 78 with a secondary brake circuit 122.

In FIG. 2 a pedal counter-force simulation device 80 is shown which is connected hydraulically with a force input element 56. The central element of the pedal counter-force simulation device is a force piston 84 tensioned against a simulation spring 82, which piston in a simulation device housing 86 encloses a hydraulic chamber 88 and is displaceable against the pretension of the simulation spring 82 in this simulation device housing 88.

The hydraulic chamber 88 is permanently connected fluidically via a hydraulic system with the hydraulic fluid chamber enclosed in the blind hole bore 62 by the piston section 60. For this in the actuation piston 64 is provided a blow bore 87 and in the primary piston 66 a connecting bore 89 and a connecting groove 91. The combination of connecting bore 89 and connecting groove 91 in the primary piston 66 also ensures a fluidic connection with the hydraulic system of the pedal counter-force simulation device 80 when the primary piston 66 and actuation piston 64 move relative to each other. The fluid system of the pedal counter-force simulation device 80 comprises a pressure sensor 90, a choke 92 and non-return valve 94. Furthermore in the hydraulic system of the pedal counter-force simulation device 80 is provided a fluid reservoir 96 which can be coupled with and decoupled from the hydraulic system via an electromagnetically controllable shut-off valve 98. Also a non-return valve 100 and a choke 102 are provided for this.

In FIG. 2 furthermore one can see that on the actuation piston 64 is provided a connecting peg 104 with which a mechanical connection exists between the actuation piston 64 and the primary piston 66. Furthermore a return spring 106 ensures a defined rest position according to the view in FIG. 2.

Furthermore in FIG. 2 it is shown that in the hydraulic line 76 of the primary circuit is provided a branch to a fluid accumulator 108, wherein the fluid accumulator 108 via an electromagnetic shut-off valve 110 can be connected with and isolated fluidically from the primary circuit 120 of the braking system.

Before it is now discussed the function of the brake force generator 10 according to the invention, the further construction of the braking system 12 according to the invention will be described below with reference to FIG. 1. FIG. 1 shows four wheel brake units 112, 114, 116 and 118, wherein the wheel brake units 116 and 118 are allocated to the primary circuit 120 and via the hydraulic line 76 are hydraulically coupled with the primary chamber 70, and wherein the wheel brake units 112 and 114 are allocated to the secondary circuit 122 which is coupled hydraulically with the secondary chamber 74 via the hydraulic line 78. The primary circuit 120 and secondary circuit 122 are constructed conventionally and also comprise two electromagnetic shut-off valves 124 and 126 or 128 and 130.

Also allocated to each wheel brake unit 112, 114, 116 and 118 is a feed shut-off valve 132 and a discharge shut-off valve 134, where the feed shut-off valves 132 are opened in their passive position and are closed by active control, and where the discharge shut-off valves 134 are closed in their passive position and opened by active control. With the feed shut-off valves 132 opened, the wheel brake units 112, 114, 116 and 118 can be supplied fluidically to achieve a braking effect. By closing the feed shut-off valve 132, the wheel brake units 112, 114, 116 and 118 can be isolated fluidically so that no braking effect can be achieved via these.

In addition pressure accumulators 136 and 138 and pressure sources 140 and 142 are provided which make the braking system 12 compatible with ABS and ESP. In other words the braking system 12 according to the invention can be controlled, even without actuation of the brake pedal 58, in the known manner via an electronic control unit not shown.

Now with reference to FIGS. 1 and 2 operating situations will be discussed in which the brake pedal 58 is pressurised by the driver with a pedal actuation force Fₚ so that a force Fₖ acts on the force input element 56. Three operating cases are distinguished here:

In conventional braking in which the braking system 12 according to the invention functions normally, on actuation of the brake pedal 58 the force input element 56 in FIGS. 1 and 2 is moved to the left. Because of the contact of piston section 46 on the collar 44, the valve sleeve 24 is also moved to the left depending on the displacement of the force input element 46. This leads to the atmosphere-tight seat 34 being moved out of the closed position shown in FIG. 2 and opened so that air can flow into the working chamber 42 from the ambient atmosphere. As however in the vacuum chamber 40 a reduced pressure (vacuum) in relation to atmospheric pressure predominates, at the moveable wall 36 a pressure difference is created so that due to the building pressure difference, the moveable wall 36 together with the control valve housing and primary piston 66 coupled thereto is moved to the left in FIGS. 1 and 2. Then the pressure builds up in the primary chamber 68 and in the secondary chamber 74, which pressure in the conventional manner is passed via opened shut-off valves 124 and 128 to the wheel brake units 112, 114, 116 and 118 in order to achieve a braking deceleration here. The pressure at the moveable wall 36 builds up until vacuum-tight seat 32 and atmosphere-tight seat 34 both lie sealing on the flange 26 of the valve element 22. Then a constant state of equilibrium is achieved.

It is found that the force Fₖ acting on the force input element 46, apart from actuation of the valve sleeve 24, does not contribute directly to the brake force generation. Rather this force is transferred via the transfer piston arrangement 48 to the hydraulic fluid enclosed between the piston section 60 and the actuation piston 64 in the blind hole bore 62. This fluid is pressurised and flows via the bore provided at the left of the connecting peg 104 into the hydraulic pedal counter-force simulation device where it flows through choke 92. In reaction to an electronic detection of pedal actuation, the shut-off valve 98 is switched out of the state shown in FIG. 2 into its other switch position so there is no connection to the fluid reservoir 96. The hydraulic fluid expelled from the blind hole bore 62 by the effect of the transfer piston arrangement 48 thus penetrates into the hydraulic chamber 88 and moves the force piston 84 against the effect of simulation spring 82. The driver thus feels at the brake pedal, via the intermediary of the transfer piston arrangement 48 and the connected hydraulic system, a pedal counter-force provided by the simulation spring 82 and the choke element 92, although the pedal force he is applying does not contribute to the brake force generation.

As soon as the driver further reduces the pedal actuation force, because of the effect of the pretension spring 50 the valve sleeve 24 is repelled, carrying with it the valve element 22. The atmosphere-tight seat 34 remains closed but the vacuum-tight seat 32 is opened so that the working chamber 42 is connected with the vacuum source 144 or the intake tract of the vehicle and the pressure difference at the moveable wall 36 is dissipated again. Then the control valve housing 20 moves back into its starting position shown in FIG. 2. The braking effect is eliminated.

On a technical defect in which the chamber arrangement no longer functions correctly so it is not possible to build up a sufficient pressure difference at the moveable wall 36, the following occurs: a movement of the valve sleeve 24 due to a pedal actuation initially remains ineffective in contrast to the normal braking case outlined above. This means that the valve housing 24 is displaced relative to the control valve housing 20 against the resistance of the pretension spring 50, where the play s is overcome. Finally the valve housing 24 with its end on the left in FIG. 2 rests on the collar 52 of the control valve housing 20 and moves this together with the primary piston 66 to the left under the effect of the force Fₖ. The pedal counter-force simulation device 80 remains substantially ineffective in such a state since, because of the open valve 98, fluid can flow out of the blind hole bore 62 into the fluid reservoir 96. The fluidic connection between the blind bore hole 62 and the hydraulic circuit of the pedal counter-force simulation device 80 via the connecting bore 89 and the connecting groove 91 remains permanent. The further movement arising from actuation of the brake pedal 58 is then transferred directly mechanically to the primary piston 66.

Thus the actuation starting from the brake pedal can be transferred directly mechanically into an actuation force and thus finally converted into a braking effect.

The braking system according to the invention can be used in particular on hybrid vehicles which for example in addition to a combustion engine are also fitted with an electric motor (not shown in detail). The electric motor can also be used as a generator, in order to recover, from the kinetic energy of the correspondingly equipped vehicle, electrical energy that can be temporarily stored in an accumulator and later used again to drive the electric motor. The vehicle deceleration occurring during the generator effect of the electric motor can be used on hybrid vehicles also for braking purposes, where in this connection we refer to “regenerative braking”.

For example it can be provided that on actuation of the brake pedal 58, first the electric motor because of its generator effect provides the vehicle deceleration essentially alone until the deceleration request from the driver expressed by the intensity of the brake pedal actuation exceeds the deceleration capacity of the generator. In such a case of moderate deceleration which does not require actuation of the wheel brake units 112, 114, 116 and 118, i.e. in a period while the deceleration effect of the generator is sufficient to meet the deceleration request of the driver, precautions are taken to avoid performing undesirable activation of the wheel brake units 112, 114, 116 and 118. For this the fluid accumulator 108 is provided. Although the brake force generator 10 works in the same way as described above for normal braking, displacement of the primary piston 66 has no direct effect on activation of the wheel brake units 112, 114, 116 and 118. With such regenerative braking namely the feed shut-off valves 132 allocated to the wheel brake units 112, 114, 116 and 118 are switched into their closed position so that no transfer of brake fluid takes place to the individual wheel brake units 112, 114, 116 and 118. Also the volume of the secondary chamber 74 remains essentially unchanged. The reduction in volume of the primary chamber 70 caused by a displacement of the primary piston 66 is compensated by switching the shut-off valve 110 into its opened position and supplying the fluid accumulator 108.

The fluid accumulator 108 in its storage capacity and rigidity is adapted to the rest of the vehicle braking system. The driver, because of the active pedal counter-force simulation device 80, perceives a pedal counter-force in the conventional manner although the braking system itself remains completely ineffective in regenerative braking and the deceleration is caused solely by the generator effect.

As soon as the driver's deceleration request exceeds the deceleration capacity of the electric motor acting as generator, it is necessary to build up additional brake force via the wheel brake units 112, 114, 116 and 118. Then the feed shut-off valves 132 are switched into their opened position so that the positive pressure present in the fluid accumulator 108 and each further brake pedal actuation can be transmitted to the wheel brake units 112, 114, 116 and 118 in the described manner. At the same time the generator is switched off. Because of adaptation of the properties of the fluid accumulator 108 to the rest of the braking system, when the generator is switched off an essentially continuous, constant (smooth) transition in braking effect occurs i.e. the braking pressure stored in the fluid accumulator 108 leads to a braking effect essentially similar to the braking effect of the generator at the wheel brake units 112, 114, 116 and 118. When the positive pressure from fluid accumulator 108 is present at the wheel brake units 112, 114, 116 and 118 and these show corresponding braking effect, the shut-off valve 110 is closed. Further braking takes place conventionally i.e. by further pressing of the brake pedal and the resulting further pressure increase in the primary circuit 120 and secondary circuit 122. As soon as braking is ended and the driver releases the brake pedal again, the shut-off valve 110 is opened again so that the residual pressure remaining in the pressure accumulator 108 can dissipate completely. The system is then back in a starting situation free from braking effect, as shown in FIGS. 1 and 2.

According to the invention a relatively simply constructed brake force generator can be actuated comfortably and in particular used even in connection with a hybrid vehicle with low technical complexity.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Brake force generator for a hydraulic vehicle braking system with
a force input element adapted to be coupled with a brake pedal and is displaceable in a base housing of the brake force generator,
a master brake cylinder in which a primary piston is guided displaceably, wherein the primary piston with the master brake cylinder delimits a primary pressure chamber to generate a hydraulic brake pressure,
a pedal counter-force simulation device selectively coupled with the force input element, and
an actuation force generating device to exert an actuation force on the primary piston,
wherein the pedal counter-force simulation device is selectively coupled fluidically with the force input element and that the actuation force generating device has a control valve and a chamber arrangement, wherein the chamber arrangement is formed with a vacuum chamber and a working chamber which is separated from the vacuum chamber via a moveable wall and is selectively connected fluidically thereto via the control valve, and wherein the control valve is controllable mechanically directly via the pedal actuation to achieve a pressure difference between the working chamber and the vacuum chamber which determines the actuation force.

2. Brake force generator according to claim 1, wherein the control valve has a control valve housing displaceable relative to the base housing and a control valve element displaceable relative to the control valve housing, wherein on the control valve housing is provided a vacuum-tight seat engageable into a sealing contact with the control valve element, wherein furthermore coupled mechanically with the force input element is a control valve housing, on which is provided an atmosphere-tight seat engageable into a sealing contact with the control valve element.

3. Brake force generator according to claim 2, wherein on sealed contact of the control valve element and atmosphere-tight seat and simultaneous separation of the control valve element and vacuum seal seat, the working chamber is fluidically connected with the vacuum chamber, and that on sealed contact of the control valve element and vacuum-tight seat and simultaneous separation of the control valve element and atmosphere-tight seat, to build up a pressure difference between the working chamber and the vacuum chamber, the working chamber is fluidically connected with the ambient atmosphere.

4. Brake force generator according to claim 2, wherein the control valve housing and control valve sleeve are mechanically decoupled from each other and only come into mutual contact after a predetermined relative movement to each other, after overcoming a play.

5. Brake force generator according to claim 4, wherein the control valve housing and control valve sleeve can be moved relative to each other under pretension by a spring element.

6. Brake force generator according to claim 1, wherein the vacuum pressure chamber, to generate a vacuum, is fluidically connected with the intake tract of one of a combustion engine and a vacuum pump.

7. Brake force generator according to claim 1, wherein the chamber arrangement is formed as a tandem chamber arrangement with a first chamber arrangement and a second chamber arrangement separate there from, the first chamber arrangement having a first vacuum chamber and a first working chamber separated therefrom by a first moveable wall, furthermore the second chamber arrangement having a second vacuum chamber and a second working chamber separated therefrom by a second moveable wall, wherein the first and second chamber arrangements are selectively pressurised via the control valve.

8. Brake force generator according to claim 1, wherein the force input element is coupled via a transfer piston arrangement with the pedal counter-force simulation device.

9. Brake force generator according to claim 1, wherein the pedal counter-force simulation device can be coupled with a damper arrangement via the pedal force counter hydraulic system in a force-transmitting manner.

10. Brake force generator according to claim 9, wherein the damper arrangement has at least one of a simulation spring that can be compressed by the force piston displaceable via the pedal counter-force hydraulic system, a fluidic damping means, and a resilient stop plate.

11. Brake force generator according to claim 9, wherein the pedal counter-force hydraulic system is formed with a controllable shut-off valve which in a first position, allows the damper arrangement and transfer piston arrangement to be hydraulically decoupled from each other and an essentially undamped movement of the transfer piston arrangement, and which in a second position, couples the damper arrangement and the transfer piston arrangement hydraulically together.

12. Brake force generator according to claim 11, wherein the pedal counter-force hydraulic system is fitted with a choke element which in the second position of the shut-off valve chokes a hydraulic fluid flow to the damper arrangement.

13. Brake force generator according to claim 11, wherein at the start of a brake pedal actuation, the shut-off valve is switched from its first position to its second position and the control is only switched from its second position to its first position after the end of the brake pedal actuation.

14. Brake force generator according to claim 1, wherein the master brake cylinder is formed in a cylinder housing, preferably as a cylinder bore open on one side.

15. Brake force generator according to claim 14, wherein the cylinder housing with the components arranged therein is inserted as an assembly in the base housing and is detachably connected therewith.

16. Brake force generator according to claim 1, wherein in the master brake cylinder is displaceably guided a secondary piston, that the secondary piston with the master brake cylinder encloses a secondary pressure chamber to generate a hydraulic brake pressure, and that the primary piston with the master brake cylinder and secondary piston, to generate a hydraulic braking pressure, encloses the primary pressure chamber.

17. Brake force generator according to claim 8, wherein the primary piston is fitted with a through bore in which is guided an actuating piston, wherein the actuating piston has an actuating cylinder bore in which is guided displaceably a transfer piston of the transfer piston arrangement, wherein the transfer piston in the actuating piston delimits a hydraulic fluid chamber which is fluidically connected with the hydraulic system of the pedal counter-force simulation device.

18. Brake force generator according to claim 17, wherein the actuation piston is fixed relative to the primary cylinder.

19. Braking system for a motor vehicle with a brake force generator according to claim 1.

20. Braking system according to claim 19, wherein the motor vehicle is formed with a generator used for deceleration and that the vehicle deceleration achieved on activation of the generator is taken into account in the control of the braking system.

21. Braking system according to claim 20, wherein the braking system has a fluidic brake circuit which communicates with the master brake cylinder and in which is provided at least one fluid accumulator, wherein the at least one fluid accumulator can be supplied with hydraulic fluid from the fluidic brake circuit as long as a nominal deceleration momentarily required to brake the vehicle does not exceed the maximum vehicle deceleration achievable by activation of the generator.

22. Braking system according to claim 21, wherein between the fluidic brake circuit and the fluid accumulator is provided a controllable change-over valve, which in its uncontrolled passive position separates the fluid accumulator from the fluidic brake circuit and in its controlled active position, in particular in the period while the nominal deceleration momentarily necessary to brake the vehicle does not exceed the maximum vehicle deceleration achievable by activation of the generator, connects the fluid accumulator with the fluidic brake circuit.
